(19) United States
(12) Patent Application Publication
(10) Pub. No.: US 2010/0026919 A1
(43) Pub. Date: Feb. 4, 2010

(54) PROJECTOR AND LIGHT MODULATION DEVICE

(75) Inventors: Taisuke YAMAUCHI, Matsumoto-shi (JP); Masayuki TAKAGI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/534,348

(22) Filed: Aug. 3, 2009

(30) Foreign Application Priority Data
Aug. 4, 2008 (JP) 2008-201150

(51) Int. Cl. G02F 1/1335; G02B 5/02; G02B 5/18; G03B 21/14

(52) U.S. Cl. 349/5; 359/599; 359/569; 349/112; 353/38

(57) ABSTRACT

A light modulation device which modulates light entering from a light source, includes: a light diffusing unit which converts diffusion angle of the light into an angle larger than that before entering the light modulation device and releases the converted light.

### BACKGROUND

1. Technical Field

The present invention relates to a projector and a light modulation device.

2. Related Art

Recently, a laser beam source has been expected as an illumination source for providing high-output light in the filed of projection type image display apparatus such as projector. The laser beam source has various advantages such as higher color reproducibility, easier immediate lighting, and longer life than those of a high-pressure mercury lamp. When the laser beam source is used, however, speckle noise is easily produced due to coherence of laser beam. In this case, projection images glare by the speckle noise thus produced, and thus projection image quality lowers. For overcoming this problem, technologies for reducing speckle noise have been proposed in JP-A-6-208089 and JP-A-2006-53495.

A non-speckle display apparatus according to JP-A-6-208089 includes a coherent light source for illuminating a spatial light modulator, and a diffusion element disposed between the spatial light modulator and the coherent light source. Light emitted from the coherent light source is modulated by the spatial light modulator after passing through the diffusion element, and projected on a scanning surface. The diffusion element is a rotation system made of frosted glass. By rotation of the diffusion element, interference patterns shift on the scanning surface at high speed and cannot be easily recognized by human eyes.

An image display system according to JP-A-2006-53495 includes a light source for emitting light having coherence, and a scanning unit for performing scanning by using the emitted light. A projection system disposed between the scanning surface to be scanned by the light and the scanning unit contains optical system for forming intermediate images. A light diffusing angle converting element for increasing diffusion angle is located at the position where the intermediate images are formed. The light diffusion angle converting element superimposes plural speckle patterns such that the respective speckle patterns cannot be easily recognized.

It is possible to reduce speckle noise by using the technologies shown in JP-A-6-208089 and JP-A-2006-53495, but the following problems arise when these technologies are practically used.

According to the technology of JP-A-6-208089, the diffusion element is disposed between the spatial light modulator and the coherent light source. Thus, the diffusion angle of light having reached the spatial light modulator becomes extremely large, which lowers light utilization efficiency and contrast. Moreover, the cost rises by increase in the number of components resulting from addition of the diffusion element and requirement of sufficient accuracy in alignment between the spatial light modulator and the diffusion element.

According to the technology of JP-A-2006-53495, the number of components of the projection system increases by addition of the light diffusion angle converting element. Thus, the cost rises by complication of the projection system, requirement of higher accuracy in alignment in the projection system, enlargement of the projection system and the like. Moreover, accuracy in alignment between the scanning unit and the light diffusion angle converting element needs to be increased. Thus, the cost further rises and practical constitution of the device becomes difficult.

### SUMMARY

It is an advantage of some aspects of the invention to provide a projector capable of producing preferable projection images by simple structure. It is another advantage of some aspects of the invention to provide a light modulation device capable of emitting light not easily producing speckle noise.

A light modulation device which modulates light entering from a light source according to a first aspect of the invention includes a light diffusing unit which converts diffusion angle of the light into an angle larger than that before entering the light modulation device and releases the converted light.

According to this structure, the proportion of wide angle components of light released from the light diffusing unit is higher than that of light before entering the light diffusing unit. Thus, interference of the light released from the light diffusing unit is not easily produced, and speckle noise is lowered. When a device includes the light modulation device having this structure, an optical system for reducing speckle noise is not required outside the light modulation device. Thus, the structure of the device can be simplified.

It is preferable that the light diffusing unit has a diffractive optical element. In this case, it is preferable that the diffractive optical element is a surface relief type element.

According to this structure, the light passing the diffractive optical element diffracts and whereby the diffusion angle of the light diffracted after passing through the diffractive optical element becomes larger than that of the light before entering the diffractive optical element. When the diffractive optical element is the surface relief type, the light intensity on the cross section crossing the released light at right angles can be controlled to have desirable distribution by appropriately designing the intervals of the concaves and convexes on the surface. Thus, optimum balance of the degree of reduction of speckle noise and the loss of light can be achieved.

It is preferable that the light diffusing unit has a light diffusing layer containing diffusing particles having refractive index different from that of a base material and dispersed in the base material.

According to this structure, fine processing required for a structure including volume-oscillation type, volume phase type, or surface relief type diffractive optical element is not needed for forming the light diffusing unit. Thus, the light modulation device can be easily manufactured.

It is preferable that diffusion intensity distribution of light emitted from a predetermined position of the light diffusing unit has at least a convex portion on both sides of the center axis of the light.

According to this structure, the proportion of wide angle components of light emitted from the light diffusing unit is higher than that in a structure which provides light diffusion intensity distribution having the maximum at the center axis of light. Thus, speckle noise can be effectively reduced.

It is preferable that diffusion intensity distribution of light emitted from a predetermined position of the light diffusing unit is a distribution having flat portion crossing the center axis of the light.

According to this structure, the range of the maximum light diffusion intensity extends wider from the center axis of light released from the light diffusing unit than that range of the light before entering the light diffusing unit. Thus, the proportion of the wide angle components of the light after released from the light diffusing unit becomes higher than that of the light before entering the light diffusing unit. Since the light diffusion intensity becomes the maximum at the center axis of light, diffraction loss is lower than that of a structure including a light diffusing unit designed to have the maximum light diffusion intensity around the center axis of light. Thus, light utilization efficiency improves.

It is preferable that the light modulation device further includes: a pair of substrates; and a liquid crystal layer sandwiched between the pair of the substrates. The light diffusing unit is provided on one of the pair of the substrates. The one substrate on which the light diffusing unit is provided is disposed on the light exit side of the liquid crystal layer.

According to this structure, light having polarization condition changed by the liquid crystal layer is released, and polarized light included in the released light and having predetermined direction is separated by a polarization unit such as polarization plate so as to modulate light having entered the light modulation device. Since the light diffusing unit is provided on one substrate disposed on the light exit side, the necessity for equipping the light diffusing unit on the other substrate disposed on the light entrance side is eliminated. Thus, speckle noise can be reduced, and diffusion angle of light before entering the liquid crystal layer can be decreased. By supplying light having small diffusion angle to the liquid crystal layer, the polarization condition of the light can be effectively changed on the liquid crystal layer, and thus light utilization efficiency improves. Since light enters in a direction close to a vertical direction with respect to the liquid crystal layer, lowering of contrast can be prevented.

It is preferable that the light modulation device further includes: a switching element provided on the one substrate on the liquid crystal layer side; a flatting film provided on the switching element; and an electrode provided on the flatting film. The light diffusing unit is overlapped with the electrode with flatness and covered by the flatting film.

According to this structure, light entering the liquid crystal layer and having polarization condition changed by electric field applied by an electrode is supplied to the light diffusing unit. Thus, speckle noise can be effectively reduced. The electrode can be formed in a preferable condition on a flat portion of the upper part of the light diffusing unit covered by the flatting film. Since cell gaps are equalized, display unevenness is not produced on projection images.

A projector according to a second aspect of the invention includes: a light source; a light modulation device which modulates light emitted from the light source; and a projection device which projects light modulated by the light modulation device. The light modulation device is the light modulation device according to the first aspect of the invention.

According to this structure, the proportion of wide angle components of light after released from the light diffusing unit is higher than that of light before entering the light diffusing unit. In this case, interference of the light released from the light diffusing unit is not easily produced, and speckle noise is lowered. Thus, the projector provides high-quality projection images. According to the light modulation device including the light diffusing unit, an optical system for reducing speckle noise is not required outside the light modulation device. Thus, the structure of the projector can be simplified.

### BRIEF DESCRIPTION OF THE DRAWINGS

The invention will be described with reference to the accompanying drawings, wherein like numbers reference like elements.

FIG. 1 is a cross-sectional view illustrating a main part of a light modulation device according to a first embodiment.

FIGS. 2A through 2C are graphs showing light distribution characteristics.

FIGS. 3A and 3B illustrate a cross-sectional structure and an enlarged main part, respectively, according to a second embodiment.

FIG. 4 illustrates a general structure of a projector according to a third embodiment.

### DESCRIPTION OF EXEMPLARY EMBODIMENTS

Exemplary embodiments according to the invention are hereinafter described. It should be understood that the technical scope of the invention is not limited by these embodiments. For easy understanding of characteristic parts of the structures as examples of various constitutions explained herein with reference to the drawings, some of the sizes and scales of the structures in the figures are different from those of actual structures.

### First Embodiment

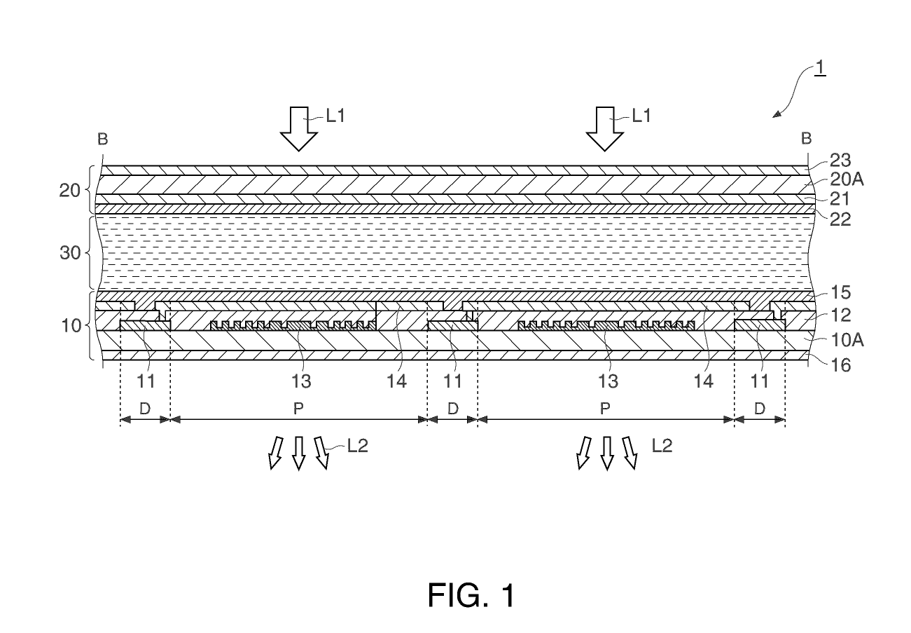

FIG. 1 is a cross-sectional view illustrating a main part of a liquid crystal light valve 1 according to a first embodiment.

As illustrated in FIG. 1, the liquid crystal light valve 1 includes an element substrate 10 and an opposed substrate 20 disposed opposed to each other, and a liquid crystal layer 30 sandwiched between the substrates 10 and 20. The liquid crystal light valve 1 in this embodiment is a transmission type light valve which has a plurality of pixels P sectioned by light shield areas D having grid shape in the plan view. The pixels herein refer to areas through which light passes. The liquid crystal light valve 1 modulates light having coherence such as laser beams and emits the modulated light. In this example, the opposed substrate 20 is disposed on the light entrance side, and the element substrate 10 is disposed on the light exit side.

The element substrate 10 is an active matrix type substrate, for example, and is formed on a transparent substrate 10A made of glass, quartz or the like as base material. Thin film transistors (hereinafter abbreviated as TFT) 11 functioning as switching elements are provided on the transparent substrate 10A on the liquid crystal layer 30 side.

The TFT 11 are formed by polycrystal silicon technology, for example, and disposed at positions overlapping with the light shield areas D. The source areas of the TFT 11 are electrically connected with signal sources for supplying image signals via data lines (not shown). The gate electrodes of the TFT 11 are electrically connected with signal sources for supplying scanning signals via scanning lines (not shown). The data lines and signal lines are disposed at positions overlapping with the light shield areas D. Light shield members (not shown) are provided on the light shield areas D at positions shifted toward the liquid crystal layer 30 from the TFT 11 such that light cannot enter the TFT 11. It is possible that respective wires such as the data lines and scanning lines function as light shield members as well. The light shield members may be disposed on either the element substrate 10 or the opposed substrate 20, or may be disposed on both of the elements 10 and 20.

Diffractive optical elements 13 are disposed on the transparent substrate 10A on the liquid crystal layer 30 side at positions corresponding to the pixels P. The diffractive optical elements 13 function as light diffusing units. The light diffusing units may be various types of diffractive optical elements such as volume oscillation type, volume phase type, and surface relief type. Alternatively, light diffusing layer containing diffusing particles may be used. A structure including the light diffusing layer will be described in “Second Embodiment”.

The diffractive optical elements 13 in this embodiment are surface relief type elements having concave and convex surfaces on the light entrance side (liquid crystal layer 30 side). The diffractive optical elements 13 are made of silicon oxides, for example, and have refractive index of about 1.5. Light having entered the diffractive optical elements 13 are diffracted by the concaves and convexes on the surfaces. Then, primary or higher diffractive lights are emitted with inclination to the entering light. Since lights released from the diffractive optical elements 13 are a flux of stacked diffractive lights containing zero-degree diffractive light, the diffusion angle becomes larger than that before entrance into the diffractive optical elements 13. The light distribution characteristics of the diffractive optical elements 13 are now discussed.

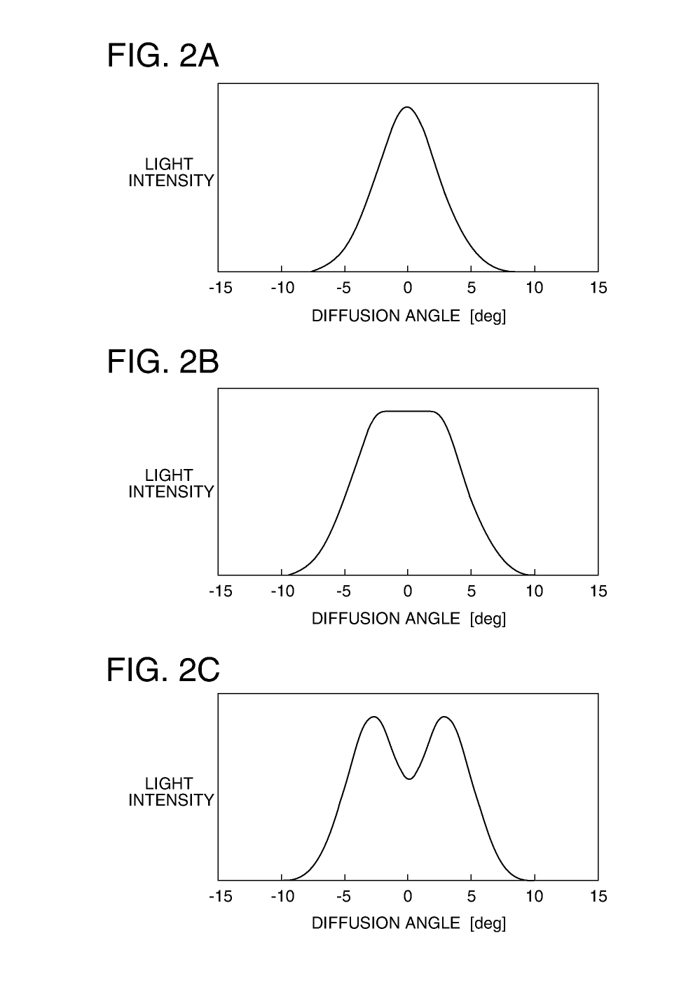

FIGS. 2A through 2C are graphs showing examples of distributions of light intensity relative to diffusion angles. In FIGS. 2A through 2C, the horizontal axis indicates diffusion angles with the center axis of light set at 0°, and the vertical axis indicates standardized intensity of lights.

FIG. 2A shows Gaussian distribution as typical diffusion distribution. The light diffusion angles can be evaluated by calculating standard deviations of the light intensity distribution for the diffusion angles, for example. In this case, the diffusion angle increases as the standard deviation becomes larger.

Coherence of light can be reduced by increasing the diffusion angle, more specifically, by increasing proportion of the amount (wide angle components) of light in an area away from the center axis of light in the amount of the entire light. The diffractive angles and the light intensity for each diffractive angle can be controlled according to refractive index of the diffractive optical elements 13, the pitch of concaves and convexes, the density of concaves and convexes and other conditions. It is preferable that the light distribution characteristics shown in FIGS. 2B and 2C are provided by controlling these conditions.

FIG. 2B shows distribution having flat-top light intensity. In the flat-top-type distribution, the light intensity becomes the maximum at the center axis of lights (diffusion angle: 0°), and substantially uniform around the center axis of lights (about −3° to 3° in this example) . Thus, the light intensity distribution has a flat portion crossing the center axis of lights. In case of the flat-top-type distribution of lights emitted from the diffractive optical elements 13, the proportion of the wide angle components is larger than that of Gaussian distribution shown in FIG. 2A, and therefore coherence becomes low. According to a typical optical element such as lens, light utilization efficiency decreases as light passes at a greater distance from the optical axis of the optical element. The amount of light passing in the vicinity of the optical axis of the optical element increases as the proportion of the amount of light distributed in the vicinity of the center axis of light rises in the whole amount of light, and light utilization efficiency improves accordingly. In the flat-top-type distribution, the amount of light in the vicinity of the center axis of light is larger than that of ring-type distribution described below. Thus, light utilization efficiency increases.

FIG. 2C shows the ring-type distribution of light intensity. In the ring-type distribution, light intensity becomes the maximum in the area around the center axis of light (diffusion angle: 0°). More specifically, the light intensity distribution has a convex at least on each side of the center axis of light. In this example, the light intensity becomes the minimum at the diffusion angle 0°, and becomes the maximum at diffusion angles −3° and 3°. In the ring-type distribution, the proportion of the wide angle components becomes larger than that of the flat-top-type distribution, and therefore coherence can be considerably reduced.

In either case of flat-top-type and ring-type distributions, it is preferable that the light diffusing unit is so designed as to release light with diffusion angle falling almost within the range from −15° to 15° for securing sufficient light utilization efficiency.

As illustrated in FIG. 1, a between-layers insulation film 12 is provided in such a manner as to cover the TFT 11 and the diffractive optical elements 13. Pixel electrodes 14 in the form of islands are equipped on the between-layers insulation film 12 at positions corresponding to the pixels P. Contact holes are formed on the between-layers insulation film 12, and the pixel electrodes 14 are electrically connected with the drain areas of the TFT 11 via the contact holes. The between-layers insulation film 12 made of material having low refractive index has lower refractive index than that of the diffractive optical elements 13. The between-layers insulation film 12 in this embodiment is made of porous silica, for example, and has refractive index of about 1.25. The between-layers insulation film 12 is formed by applying liquid material such as silica by spin coat method or other coating method, and then sintering the coated film, for example. By this method, concaves and convexes produced by various wires such as the TFT 11 and data lines and by the diffractive optical elements 13 can be flatted. As a result, the between-layers insulation film 12 can function as the flatting layer capable of making the concaves and convexes flat.

An orientation film 15 for controlling the orientation of the liquid crystal layer 30 is provided between the pixel electrode 14 and the liquid crystal layer 30. A polarization plate 16 is disposed on the transparent substrate 10A on the side opposite to the liquid crystal layer 30.

The opposed substrate 20 is formed on a transparent substrate 20A as base material made of glass, quartz or the like. A common electrode 21 extends throughout the transparent substrate 20A on the liquid crystal layer 30 side. An orientation film 22 for controlling the orientation of the liquid crystal layer 30 is disposed between the common electrode 21 and the liquid crystal layer 30. A polarization plate 23 is equipped on the transparent substrate 20A on the side opposite to the liquid crystal layer 30.

In the liquid crystal light valve 1 having this structure, the TFT 11 are turned on when a scanning signal is supplied to the gate electrodes of the TFT 11. By turning on the TFT 11, an image signal is transmitted to the pixel electrodes 14 via the data lines and the TFT 11. Then, voltage corresponding to the image signal is applied between the pixel electrodes 14 and the common electrode 21 such that electric field can be applied to the liquid crystal layer 30 for each pixel P. As a result, azimuth angles of liquid crystal molecules on the liquid crystal layer 30 are controlled according to the electric field thus applied.

Light L1 entering the liquid crystal light valve 1 from a not-shown light source passes the polarization plate 23 to become predetermined polarized light (such as linear polarized light) and enters the liquid crystal layer 30. The light having entered the liquid crystal layer 30 changes its polarization condition according to the azimuth angles of the liquid crystal molecules to become linear polarized light in a direction different from the direction of entering the liquid crystal layer 30, for example, and enters the element substrate 10. The light having entered the element substrate 10 diffracts by the function of the diffractive optical element 13. Thus, the light obtains a larger proportion of wide angle components and reduces coherence. Then, a part of the light released from the diffractive optical elements 13 is absorbed by the polarization plate 16 according to the polarization condition, and separated as light having gradation corresponding to the image signals.

According to the liquid crystal light valve 1 including the diffractive optical elements 13 in the first embodiment, coherence of light L2 released from the liquid crystal light valve 1 is lower than that of the light L1 before entering the liquid crystal light valve 1. Thus, speckle noise produced by interference with the light L2 can be considerably reduced, and a preferable device including the liquid crystal light valve 1 can be manufactured. For example, a projector including the liquid crystal light valve 1 can produce high-quality projection images having no glaring. Moreover, by reduction of coherence of light using the liquid crystal light valve 1, no optical component for decreasing coherence of light is required for the illumination system or the projection system. Thus, the device structure can be simplified, and reduction of the cost and size of the device can be achieved.

The diffractive optical element 13 used as light diffusing unit can obtain desired light distribution characteristics by controlling the pitch and density of the concaves and convexes. Thus, the degree of reduction of speckle noise, and utilization efficiency of light released from the liquid crystal light valve 1 can be controlled with high accuracy.

### Second Embodiment

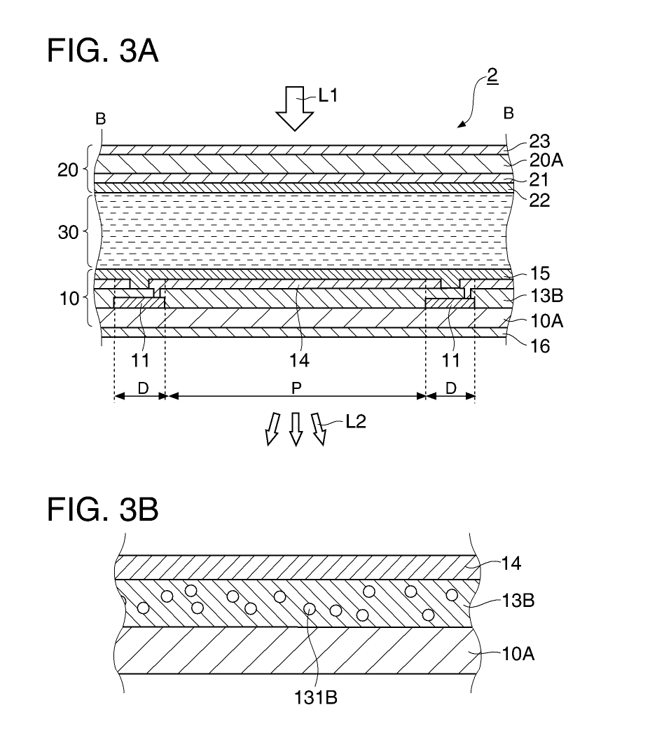

FIG. 3A is a cross-sectional view of a general structure of a liquid crystal light valve 2 according to a second embodiment. FIG. 3B is an enlarged view of a light diffusing unit.

As illustrated in FIG. 3A, the liquid crystal light valve 2 has a structure similar to that of the liquid crystal light valve 1 in the first embodiment except that the light diffusing unit is constituted by a light diffusing layer. In this example, a between-layers insulation film disposed between the TFT 11 and the pixel electrodes 14 function as a light diffusing layer 13B.

As illustrated in FIG. 3B, the light diffusing layer 13B contains diffusing particles 131B for scattering light as a volume scattering type light diffusing unit. The light diffusing layer 13B in this embodiment is formed using liquid material which contains solution having resin material such as acrylic resin as base material and the diffusing particles 131B constituted by titanium dioxide dispersed in the solution. The particle diameter of each diffusing particle is selected from the range of scale substantially equal to that of the wavelength of the light L1 entering the liquid crystal light valve 2 (such as 1 to 10 times longer than the wavelength). In this example, the particle diameter is set at about 1 μm.

The light diffusing layer 13B is produced by drying and sintering the coated film to which the liquid material has been applied by spin coat method or other coating methods. The light diffusing layer 13B thus obtained can control light distribution characteristics according to the particle diameter and material property (refractive index) of the diffusing particles 131B, the number of the diffusing particles 131B contained in the light diffusing layer 13B (density) and the like.

According to the liquid crystal light valve 2 including the light diffusing layer 13B in the second embodiment, speckle noise of the emitted light L2 can be considerably reduced similarly to the first embodiment. Moreover, the light diffusing layer 13B can be produced far more easily than the light diffusing unit such as volume oscillation type, volume phase type, and surface relief type. Thus, the light modulation device can be manufactured at low cost.

While the light diffusing unit is disposed on the between-layers insulation film in the first and second embodiments, the light diffusing unit may be provided on the optical path between the surface for receiving light from the outside and the surface for releasing the light in the liquid crystal light valve. For example, the light diffusing unit may be disposed on the opposed substrate 20 located at a position shifted toward the light entrance side from the liquid crystal layer 30. In this case, advantages similar to those of the first and second embodiments can be offered in view of reduction of speckle noise. When the light diffusing unit is disposed on the element substrate 10 located at a position shifted toward the light exit side from the liquid crystal layer 30 as in the first and second embodiments, the polarization condition of light passing the liquid crystal layer 30 can be effectively varied. Thus, light utilization efficiency improves.

It is possible to dispose the element substrate 10 on the light entrance side and the opposed substrate 20 on the light exit side. In this case, both reduction of speckle noise and increase in light utilization efficiency can be achieved by positioning the light diffusing unit on the opposed electrode 20. When a light shielding member is provided on the transparent substrate 10A side of the TFT 11 in the structure disposing the element substrate 10 on the light entrance side, faulty operation caused by entrance of light into the TFT 11 can be prevented.

The light diffusing unit is not required to be equipped on the between-layers insulation film on the element substrate 10, but may be provided as concaves and convexes on the surface of the pixel electrodes 14 to function as diffractive optical element, for example. Alternatively, various types of insulation film such as passivation film and substrate insulation film may be constituted by the diffractive optical element, or a part of the between-layers insulation film may be constituted by the light diffusing unit.

The light diffusing unit may be provided throughout the pixels and light shielding areas rather than selectively provided at the portions overlapping with the pixels with flatness. For example, in the structure including the light diffusing unit constituted by the light diffusing layer, the light diffusing layer may be provided throughout the transparent substrate 10A such that the TFT and the like can be formed on the light diffusing layer. In this case, the necessity for patterning the light diffusing layer is eliminated, and the light diffusing unit can be manufactured considerably easily.

While the transmission type liquid crystal light valve has been discussed in the first and second embodiments, the same technologies can be applied to a reflection type liquid crystal light valve, or a light modulation device not using liquid crystal technique such as digital mirror device (DMD). By disposing the light diffusing unit on the optical path of the light modulation device, speckle noise can be reduced. When the technologies in the first and second embodiments are applied to a transmission type light modulation device as in these embodiments, both reduction of diffusion angles of light before modulation and relative increase in diffusion angles of light after modulation can be achieved. Thus, light utilization efficiency improves. In case of transmission type, it is preferable that the light modulation device is constituted by a liquid crystal light valve, which is recognized as preferable transmission type light modulation device and can satisfy improvement of light utilization efficiency, reduction of speckle noise, and sufficient reliability.

### Third Embodiment

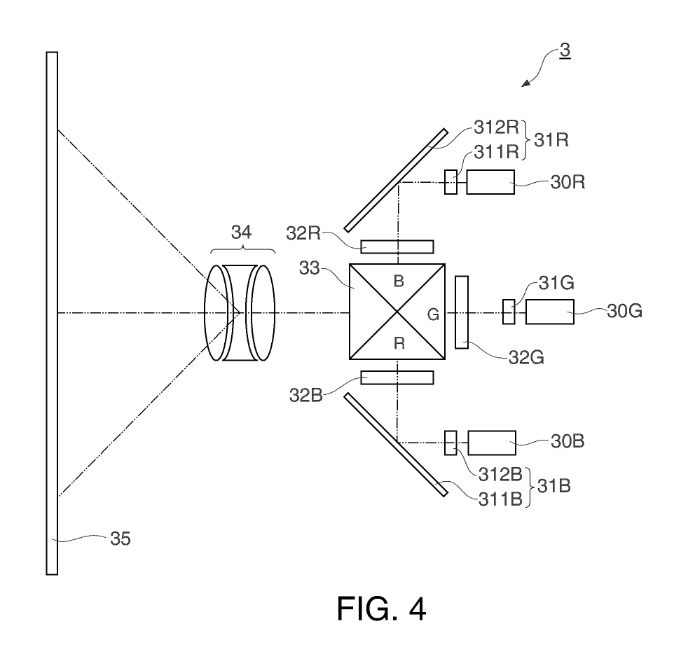

A projector according to a third embodiment of the invention is now described. FIG. 4 schematically illustrates a projector 3 according to this embodiment.

As illustrated in FIG. 4, the projector 3 includes laser beam source devices 30R, 30G, and 30B, and transmission type liquid crystal light valves (light modulation devices) 32R, 32G, and 32B, a cross dichroic prism 33, and a projection device 34. Illumination systems 31R, 31G, and 31B are disposed between the laser beam source devices 30R, 30G, and 30B and the liquid crystal light valves 32R, 32G, and 32B. The laser beam source devices 30R, 30G, and 30B emit red light, green light, and blue light, respectively, and the respective color lights thus emitted are modulated by the liquid crystal light valves 32R, 32G, and 32B. The modulated respective color lights are combined by the cross dichroic prism 33, and the combined light is projected by the projection device 34.

The illumination system 31R includes a holographic optical element 311R (hereinafter referred to as CGH) for enlarging beam diameter of light emitted from the laser beam source device 30R, and a mirror 312R for reflecting light released from the CGH 311R toward the liquid crystal light valve 32R. The illumination system 31G has a structure similar to that of the illumination system 31R except that a mirror is not provided.

Each of the liquid crystal light valves 32R, 32G, and 32B is constituted by the light modulation device according to the invention. Thus, coherence of the respective color lights supplied from the liquid crystal light valves 32R, 32G, and 32B is lower than that of the lights emitted from the laser beam source devices 30R, 30G, and 30B.

The cross dichroic prism 33 is produced by affixing four rectangular prisms. A dielectric multilayer film for reflecting red light and a dielectric multilayer film for reflecting blue light are disposed in cross shape on the inner surface of the cross dichroic prism 33. The three color lights are combined by these dielectric multilayer films to be converted into light representing color image.

The combined light is expanded and projected on a screen 35 by the projection device 34 having a projection lens. The F number of the projection lens is controlled such that the lights released from the liquid crystal light valves 32R, 32G, and 32B can be formed on the screen 35 in a preferable condition in correspondence with the increased wide angle components of the released lights. Thus, a preferable projection image can be produced.

According to the projector 3 in this embodiment, coherence of the respective color lights released from the liquid crystal light valves 32R, 32G, and 32B is low. Thus, speckle noise generated on the projection image due to interference can be prevented, and high-quality projection images can be produced. Since coherence is reduced by using the liquid crystal light valves 32R, 32G, and 32B, the necessity for equipping additional optical component for reducing coherence is eliminated. Thus, the structure of the projector can be simplified, and the cost of the projector can be lowered.

While the transmission type liquid crystal light valves are used as light modulation devices, a reflection type liquid crystal light valve, or a light modulation device not using liquid crystal technique such as digital mirror device (DMD) may be employed. The structure of the projection system may be varied according to types of light modulation device to be used. Moreover, while the cross dichroic prism is used as color light combining unit, other devices such as a type including dichroic mirrors disposed in cross shape for combining color lights, and a type including dichoric mirrors disposed in parallel for combining color lights may be employed.

The light modulation device according to the invention is applicable to both front-type and rear-type projectors, and also to other devices such as laser processing device. The light modulation device of the invention applied to any of these devices can reduce coherence of light emitted from a coherent light source. When the light modulation device of the invention is applied to a lamp light source, generation of scintillation on images can be prevented. Accordingly, a device having simple structure and capable reducing speckle noise and scintillation can be provided.

The entire disclosure of Japanese Patent Application No. 2008-201150, filed Aug. 4, 2008 is expressly incorporated by reference herein.

What is claimed is:

1. A light modulation device which modulates light entering from a light source, comprising:
a light diffusing unit which converts diffusion angle of the light into an angle larger than that before entering the light modulation device and releases the converted light.

2. The light modulation device according to claim 1, wherein the light diffusing unit has a diffractive optical element.

3. The light modulation device according to claim 2, wherein the diffractive optical element is a surface relief type element.

4. The light modulation device according to claim 1, wherein the light diffusing unit has a light diffusing layer containing diffusing particles having refractive index different from that of a base material and dispersed in the base material.

5. The light modulation device according to claim 1, wherein diffusion intensity distribution of light emitted from a predetermined position of the light diffusing unit has at least a convex portion on both sides of the center axis of the light.

6. The light modulation device according to claim 1, wherein diffusion intensity distribution of light emitted from a predetermined position of the light diffusing unit is a distribution having flat portion crossing the center axis of the light.

7. The light modulation device according to claim 1, further comprising:
a pair of substrates; and
a liquid crystal layer sandwiched between the pair of the substrates,
wherein
the light diffusing unit is provided on one of the pair of the substrates, and
the one substrate on which the light diffusing unit is provided is disposed on the light exit side of the liquid crystal layer.

8. The light modulation device according to claim 7, further comprising:
a switching element provided on the one substrate on the liquid crystal layer side;
a flatting film provided on the switching element; and
an electrode provided on the flatting film,
wherein the light diffusing unit is overlapped with the electrode with flatness and covered by the flatting film.

9. A projector, comprising:
a light source;
a light modulation device which modulates light emitted from the light source; and
a projection device which projects light modulated by the light modulation device,
wherein the light modulation device has a light diffusing unit which converts diffusion angle of the light into an angle larger than that before entering the light modulation device and releases the converted light.

10. The projector according to claim 9, wherein the light diffusing unit has a diffractive optical element.

11. The projector according to claim 10, wherein the diffractive optical element is a surface relief type element.

12. The projector according to claim 9, wherein the light diffusing unit has a light diffusing layer containing diffusing particles having refractive index different from that of a base material and dispersed in the base material.

13. The projector according to claim 9, wherein diffusion intensity distribution of light emitted from a predetermined position of the light diffusing unit has at least a convex portion on both sides of the center axis of the light.

14. The projector according to claim 9, wherein diffusion intensity distribution of light emitted from a predetermined position of the light diffusing unit is a distribution having flat portion crossing the center axis of the light.

15. The projector according to claim 9, further comprising:
a pair of substrates; and
a liquid crystal layer sandwiched between the pair of the substrates,
wherein
the light diffusing unit is provided on one of the pair of the substrates, and
the one substrate on which the light diffusing unit is provided is disposed on the light exit side of the liquid crystal layer.

16. The projector according to claim 15, further comprising:
a switching element provided on the one substrate on the liquid crystal layer side; and
a flatting film provided on the switching element; and
an electrode provided on the flatting film,
wherein the light diffusing unit is overlapped with the electrode with flatness and covered by the flatting film.

17. The projector according to claim 15, wherein the light diffusing unit has a diffractive optical element.

18. The projector according to claim 17, wherein the diffractive optical element is a surface relief type element.

19. The projector according to claim 15, wherein diffusion intensity distribution of light emitted from a predetermined position of the light diffusing unit has at least a convex portion on both sides of the center axis of the light.

20. The projector according to claim 15, wherein diffusion intensity distribution of light emitted from a predetermined position of the light diffusing unit is a distribution having flat portion crossing the center axis of the light.
